(19) United States
(12) Patent Application Publication
(10) Pub. No.: US 2022/0100957 A1
(43) Pub. Date: Mar. 31, 2022

(54) INFORMATION PROCESSING APPARATUS, INFORMATION PROCESSING SYSTEM, AND NON-TRANSITORY COMPUTER READABLE MEDIUM

(71) Applicant: FUJIFILM BUSINESS INNOVATION CORP., Tokyo (JP)

(72) Inventor: Tadafumi KAWAGUCHI, Kanagawa (JP)

(73) Assignee: FUJIFILM BUSINESS INNOVATION CORP., Tokyo (JP)

(21) Appl. No.: 17/335,779

(22) Filed: Jun. 1, 2021

(30) Foreign Application Priority Data
Sep. 30, 2020 (JP) 2020-166322

(51) Int. Cl. G06F 40/279; G06F 40/169; G06F 3/0482; G06N 20/00; G06N 5/04; G06F 16/24

(52) U.S. Cl. CPC G06F 40/279; G06F 40/169; G06F 16/24; G06N 20/00; G06N 5/04; G06F 3/0482

(57) ABSTRACT

An information processing apparatus includes a processor configured to: receive a query; and, when the received query includes a predetermined underlearned word, receive, as information for learning the underlearned word, annotation information for the underlearned word.

### CROSS-REFERENCE TO RELATED APPLICATIONS

This application is based on and claims priority under 35 USC 119 from Japanese Patent Application No. 2020-166322 filed Sep. 30, 2020.

### BACKGROUND

### (i) Technical Field

The present disclosure relates to an information processing apparatus, an information processing system, and a non-transitory computer readable medium.

### (ii) Related Art

In Japanese Patent No. 5165719, an information processing apparatus has been proposed. The information processing apparatus stores a log including queries, search lists for the queries, and the history information about selections of the sites included in the search lists. The degree of similarity between stored queries is calculated on the basis of the distribution of the selection counts of the sites included in the stored search lists. On the basis of calculation results from a calculation unit, a set of queries is extracted as similar queries.

In Japanese Patent No. 5296745, a query-suggestion providing apparatus has been proposed. The query-suggestion providing apparatus refers to a search log indicating a series of search operations, each of which includes a search query and a re-search query, and calculates scores indicating the degrees of association between search queries included in the series of search operations. In addition, the query-suggestion providing apparatus calculates scores by providing a high weight to scores between the last query in the series of search operations and the other search queries. After that, in reception of a search query from a user terminal, the query-suggestion providing apparatus provides, to the user terminal, search queries having high scores with respect to the received search query.

In “Enriching Word Vectors with Subword Information” (Piotr Bojanowski, Edouard Grave, Armand Joulin, Tomas Mikolov, TACL2017), a technique has been proposed for calculation of the feature value of an unknown word from the feature values of the components of the unknown word, and for evaluation of related words using the calculated feature value.

In “Semantic Specialization of Distributional Word Vector Spaces using Monolingual and Cross-Lingual Constraints” (Nikola Mrkšić, Ivan Vulić, Diarmuid Ó Séaghdha, Ira Leviant, Roi Reichart, Milica Gašić, Anna Korhonen, Steve Young, TACL2017), a technique has been proposed for recalculation of feature values using of pairs of related words.

When a learning machine learns the meaning of an underlearned word, learning using information deduced from known words may cause learning of a meaning far from the actual meaning of the word.

### SUMMARY

Aspects of non-limiting embodiments of the present disclosure relate to an information processing apparatus, an information processing system, and a non-transitory computer readable medium which enables acquisition of more appropriate information as information for learning when a learning machine learns an underlearned word, compared with the case of learning using information deduced from known words.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: receive a query; and, when the received query includes a predetermined underlearned word, receive, as information for learning the underlearned word, annotation information for the underlearned word.

### BRIEF DESCRIPTION OF THE DRAWINGS

Exemplary embodiments of the present disclosure will be described in detail based on the following figures, wherein:

FIG. 1 is a diagram illustrating a schematic configuration of an information processing system according to the present exemplary embodiment;

FIG. 2 is a block diagram illustrating the configuration of a relevant part of the electric system of each of an information processing terminal and a server in an information processing system according to the present exemplary embodiment;

FIG. 3 is a functional block diagram illustrating the functional configuration of a server in an information processing system according to a first exemplary embodiment;

FIG. 4 is a diagram illustrating an example describing how to perform annotation;

FIG. 5 is a diagram illustrating an exemplary search/recommendation result display screen;

FIG. 6 is a flowchart of an exemplary process performed by a server in an information processing system according to the first exemplary embodiment;

FIG. 7 is a functional block diagram illustrating the functional configuration of a server in an information processing system according to a second exemplary embodiment;

FIG. 8 is a flowchart of an exemplary process performed by a server in an information processing system according to the present exemplary embodiment;

FIG. 9 is a diagram illustrating an exemplary search/recommendation result display screen in which non-related words among the words displayed in a recommended-word area may be deleted; and

FIG. 10 is a flowchart of an exemplary process performed in the case where non-related recommended words may be deleted.

### DETAILED DESCRIPTION

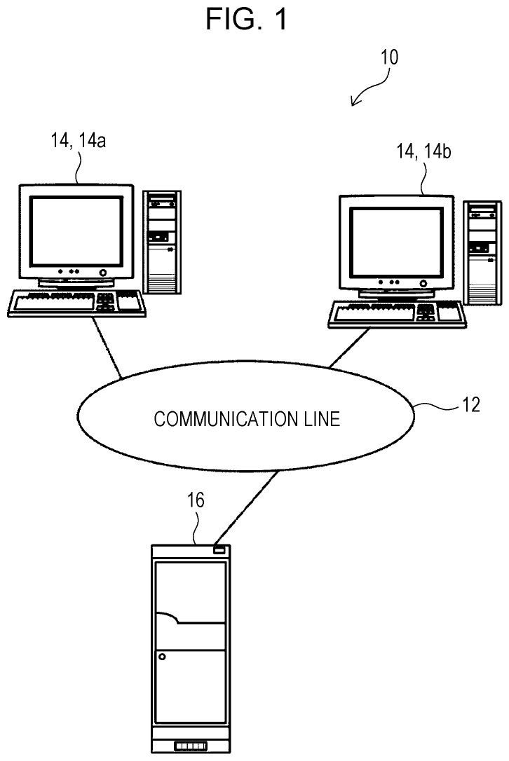

Exemplary embodiment will be described below by referring to the drawings. The present exemplary embodiment will be described by taking, as an example, an information processing system in which multiple information processing terminals and a server are connected to each other through communication lines such as various networks. FIG. 1 is a diagram illustrating a schematic configuration of an information processing system 10 according to the present exemplary embodiment.

As illustrated in FIG. 1, the information processing system 10 according to the present exemplary embodiment includes multiple information processing terminal 14a, 14b, . . . and a server 16 which serves as an information processing apparatus. When the information processing terminals 14a, 14b, . . . discriminated from each other are not necessarily described, the alphabets added to the end of the reference characters may be omitted. The present exemplary embodiment describes an example including multiple information processing terminals 14a, 14b, . . . . Alternatively, there may be only one information processing terminal 14.

The information processing terminals 14 and the server 16 are connected to each other through a communication line 12, such as a local area network (LAN), a wide area network (WAN), the Internet, or an intranet. The information processing terminals 14 and the server 16 are capable of receiving/transmitting various data from/to each other through the communication line 12.

In the information processing system 10 according to the present exemplary embodiment, the server 16 provides search services, such as site search and document search, in accordance with requests from the information processing terminals 14.

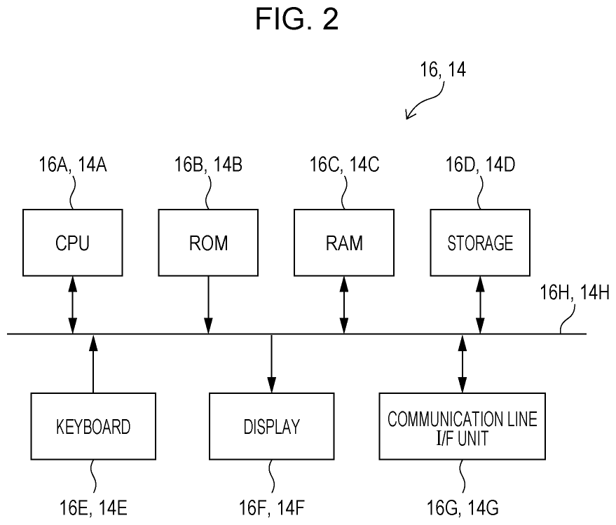

The configuration of a relevant part of the electric system of each of the information processing terminals 14 and the server 16 according to the present exemplary embodiment will be described. FIG. 2 is a block diagram illustrating the configuration of a relevant part of the electric system of each of the information processing terminals 14 and the server 16 in the information processing system 10 according to the present exemplary embodiment. Each of the information processing terminals 14 and the server 16 has a typical computer configuration in most cases. Herein, the description will be made by taking the server 16 as a typical apparatus.

As illustrated in FIG. 2, the server 16 according to the present exemplary embodiment includes a central processing unit (CPU) 16A serving as a processor, a read-only memory (ROM) 16B, a random-access memory (RAN) 16C, a storage 16D, a keyboard 16E, and a display 16F, and a communication line interface (I/F) unit 16G. The CPU 16A controls the entire operation of the server 16. The ROM 16B is used to store, for example, various control programs and various parameters in advance. The RAM 16C is used, for example, as a work area in the CPU 16A's execution of the various programs. The storage 16D stores, for example, various data and application programs. The keyboard 16E is used for input of various types of information. The display 16F is used for display of various types of information. The communication line I/F unit 16G, which is connected to the communication line 12, receives/transmits various data from/to other apparatuses connected to the communication line 12. The units of the server 16 described above are connected to each other electrically through a system bus 16H. The server 16 according to the present exemplary embodiment uses the storage 16D as a storage unit. This is not limiting. Other nonvolatile storage units such as a flash memory may be used.

In the configuration described above, the server 16 according to the present exemplary embodiment uses the CPU 16A to access the ROM 16B, the RAM 16C, and the storage 16D, obtain various data through the keyboard 16E, and display various types of information on the display 16F. The server 16 uses the CPU 16A to control reception/transmission of communication data through the communication line I/F unit 16G.

In the information processing system 10 according to the present embodiment having such a configuration, when, for example, a search word is input as a query from an information processing terminal 14, sites, sentences, and the like including the input word are searched for. In the present exemplary embodiment, words related to the input word entered as a query are displayed as recommended words. The recommended words are derived by using a learning machine which has learned the feature values of words.

In the present exemplary embodiment, words, which have been learned by the learning machine insufficiently for derivation of recommended words, and words, which have not been learned at all, are inclusively referred to as underlearned words. Words, which have not been learned at all, are referred to as unknown words. Herein, association of information, which relates to an underlearned word, with the underlearned word for the learning machine's learning is referred to as annotation. The information associated with an underlearned word is referred to as annotation information.

### First Exemplary Embodiment

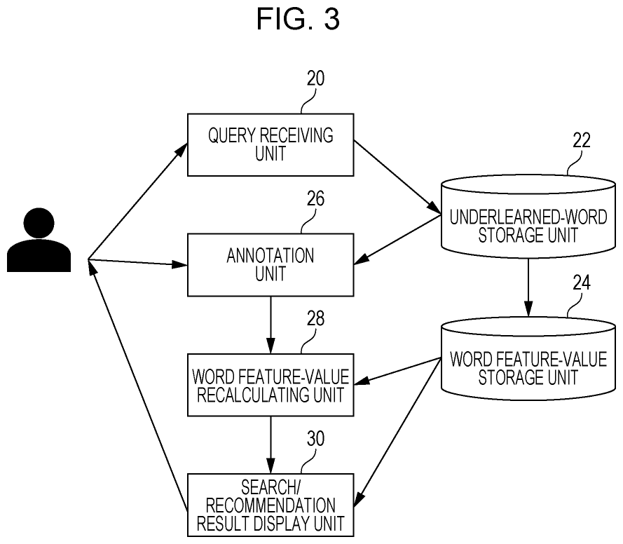

The functional configuration implemented by the CPU 16A of the server 16 executing programs stored in the ROM 16B will be described. FIG. 3 is a functional block diagram illustrating the functional configuration of the server 16 in the information processing system 10 according to a first exemplary embodiment.

As illustrated in FIG. 3, the server 16 includes functions of a query receiving unit 20, an underlearned-word storage unit 22, a word feature-value storage unit 24, an annotation unit 26, a word feature-value recalculating unit 28, and a search/recommendation result display unit 30.

The query receiving unit 20 receives, for example, a search word or text as a query from an information processing terminal 14.

The underlearned-word storage unit 22, which is implemented, for example, by using the storage 16D, stores predefined underlearned words. For example, when a word, which is entered by a user, is an unknown word, the word may be registered as an underlearned word with the underlearned-word storage unit 22. Alternatively, when a user performs a search, checks recommended words and search results, and does not obtain a desired result, the input word may be added as an underlearned word. Alternatively, a user may add an underlearned word optionally. Alternatively, an underlearned word may be determined statistically on the basis of user actions and may be added. For example, when a user adds a word as a query more than a predetermined number of times for word recommendation results related to the input word entered as a query, or for search results, such as sites or documents including the input word, the input word may be added as an underlearned word.

The word feature-value storage unit 24, which is implemented, for example, by using the storage 16D, stores the feature values of words used to search for words and texts similar to a word entered as a query.

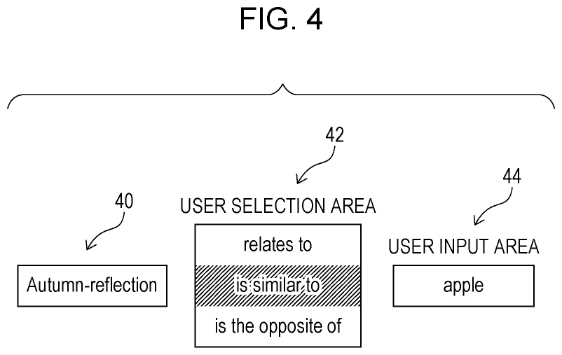

The annotation unit 26 requests annotation from a user when at least one word received by the query receiving unit 20 includes an underlearned word. For example, as illustrated in FIG. 4, “Autumn-reflection”, which indicates one variety of apple, is entered in a query input area 40. When “Autumn-reflection” is included in the underlearned-word storage unit 22, a user is requested to make a selection in a user selection area 42 in FIG. 4 and enter annotation information in a user input area 44. In the case of the example in FIG. 4, the user selects one of the relationships, such as “relates to”, “is similar to”, and “is the opposite of”, in the user selection area 42. Assume that the user selects “is similar to”. The user enters, in the user input area 44, a word having the relationship, “is similar to”, with “Autumn-reflection”. FIG. 4 illustrates an example in which “apple” is entered in the user input area 44. As in the example in FIG. 4, the user uses the annotation unit 26 to perform an annotation method using a predicate and an object for a query, which is entered by the user. The predicate is selected from predetermined candidates (in the example in FIG. 4, three types of “relates to”, “is similar to”, and “is the opposite of”). The object is entered freely.

The word feature-value recalculating unit 28 uses the annotation result from the annotation unit 26 to recalculate the feature value of the underlearned word to learn the underlearned word. For example, a technique, such as Word2Vec or FastText, is used to calculate the feature vector of the word. The word feature-value recalculating unit 28 uses the recalculation result of the feature value of the underlearned word to update the feature value of the word stored in the word feature-value storage unit 24. The method of recalculating a feature value may be changed depending on the relationship between words.

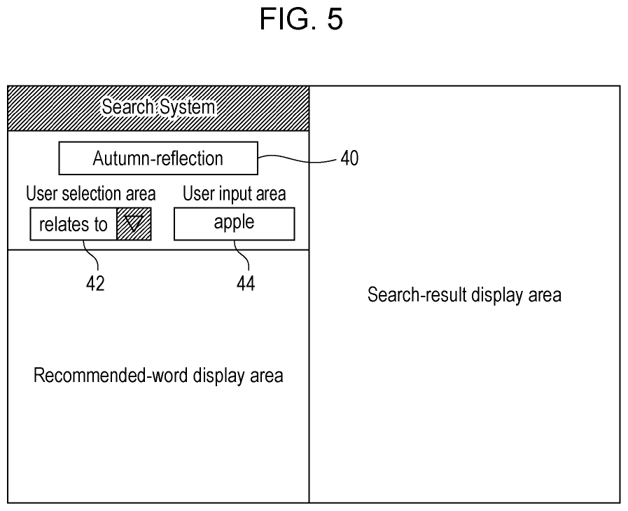

The search/recommendation result display unit 30 displays, on the display 14F of the information processing terminal 14, search results of sites, documents, and the like which include at least one word that is entered in the input query area and that is received by the query receiving unit 20. The search/recommendation result display unit 30 displays, on the display 14F of the information processing terminal 14, words, which relate to a word that is entered in the input query area and that is received by the query receiving unit 20, as recommendation results. For example, the search/recommendation result display unit 30 displays the search/recommendation result display screen, which is illustrated in FIG. 5, on the display 14F by transmitting the screen to the information processing terminal 14. The example in FIG. 5 is an exemplary screen displayed when the following operations are performed: “Autumn-reflection” is entered as a query; “relates to” in the user selection area 42 is selected as annotation information; “apple” is entered in the user input area 44. In the recommended-word display area in FIG. 5, words relating to a word entered as a query are displayed as recommended words. In the search-result display area, search results of sites, documents, and the like, which include the word entered as a query, are displayed.

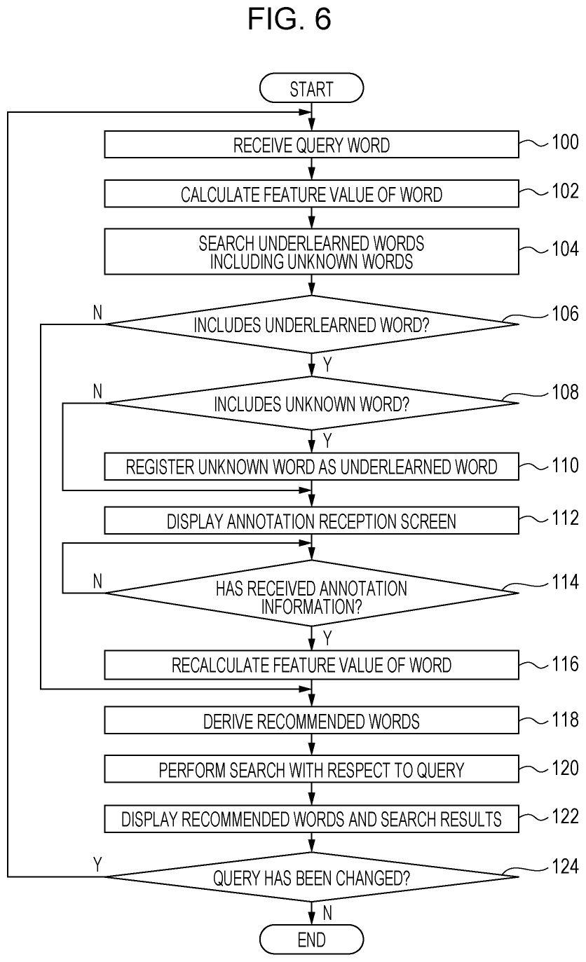

Specific processes performed by the server 16 of the information processing system 10 according to the first exemplary embodiment having the configuration described above will be described. FIG. 6 is a flowchart of an exemplary process performed by the server 16 of the information processing system 10 according to the first exemplary embodiment. The process in FIG. 6 starts when the keyboard 14E of an information processing terminal 14 is operated and a query is entered.

In step 100, the CPU 16A receives at least one word for query, and the process proceeds to step 102. That is, the query receiving unit 20 receives at least one word entered as a query by using the information processing terminal 14.

In step 102, the CPU 16A calculates the feature value of the at least one word entered as a query, and the process proceeds to step 104. For example, a technique, such as Word2Vec or FastText, is used to calculate the feature vector of the at least one word.

In step 104, the CPU 16A searches underlearned words including unknown words, and the process proceeds to step 106. That is, the query receiving unit 20 searches the word feature-value storage unit 24 and the underlearned-word storage unit 22 for the at least one word received in step 100. If a word feature value corresponding to the feature value of the at least one word received by the query receiving unit 20 is not found in the word feature-value storage unit 24, the at least one word is regarded as an unknown word. If the at least one word received by the query receiving unit 20 is stored in the underlearned-word storage unit 22, the at least one word is regarded as an underlearned word.

In step 106, the CPU 16A determines whether the at least one word entered as a query includes an underlearned word encompassing an unknown word. That is, the query receiving unit 20 determines whether the at least one word entered as a query includes a word, whose feature value is not stored in the word feature-value storage unit 24, or a word stored in the underlearned-word storage unit 22. If the determination result is positive, the process proceeds to step 108. If the determination result is negative, the process proceeds to step 118.

In step 108, the CPU 16A determines whether the at least one word entered as a query includes an unknown word. That is, the CPU 16A determines whether the at least one word having been determined as an underlearned word is a word which is not stored in the underlearned-word storage unit 22 and whose feature value is not stored in the word feature-value storage unit 24. If the determination result is positive, the process proceeds to step 110. If the determination result is negative, the process proceeds to step 112.

In step 110, the CPU 16A registers the unknown word as an underlearned word with the underlearned-word storage unit 22, and the process proceeds to step 112.

In step 112, the CPU 16A displays a predetermined annotation reception screen on the display 14F of the information processing terminal 14, and the process proceeds to step 114. That is, the annotation unit 26 transmits, to the information processing terminal 14, the predetermined annotation reception screen including the user selection area 42 and the user input area 44 illustrated in FIG. 4, and thus displays the annotation reception screen on the display 14F of the information processing terminal 14.

In step 114, the CPU 16A determines whether annotation information has been received. That is, the annotation unit 26 determines whether a user has operated the keyboard 14E, a mouse, and the like of the information processing terminal 14 to perform an input operation on the annotation reception screen. The process waits until the determination result is positive, and proceeds to step 116.

In step 116, the CPU 16A recalculates the feature value of the at least one word by using the annotation result, and the process proceeds to step 118. That is, the word feature-value recalculating unit 28 uses the annotation result from the annotation unit 26 to recalculate the feature value of the at least one word. Thus, the word feature-value recalculating unit 28 learns the underlearned word, and updates the word feature-value storage unit 24. For example, a technique, such as Word2Vec or FastText, is used to calculate the feature vector of the at least one word. If the learning becomes sufficient in this step, for example, if the underlearned word has been learned a predetermined number of times, the word feature-value recalculating unit 28 may delete the word stored in the underlearned-word storage unit 22, and may exclude the word from the underlearned words. Alternatively, a user may transmit an instruction to exclude the word from the underlearned words.

In step 118, the CPU 16A derives recommended words relating to the at least one word entered as a query, and the process proceeds to step 120. That is, the feature value of the at least one word calculated in step 102 or the feature value of the at least one word recalculated in step 116, and the feature values of the words stored in the word feature-value storage unit 24 are used to derive words, which relate to the at least one word entered as a query, as recommended words.

In step 120, the CPU 16A performs a search with respect to the query, and the process proceeds to step 122. That is, sites, documents, and the like including the at least one word entered as a query are searched for.

In step 122, the CPU 16A displays the recommended words and the search results, and the process proceeds to step 124. That is, the search/recommendation result display unit 30 displays, on the display 14F of the information processing terminal 14, the search results of sites, documents, and the like including the at least one word which is entered as a query and which is received by the query receiving unit 20. The search/recommendation result display unit 30 displays, on the display 14F of the information processing terminal 14, words, which relate to the at least one word which is entered in the input query area and which is received by the query receiving unit 20, as recommendation results. For example, the search/recommendation result display unit 30 transmits, to the information processing terminal 14, the search/recommendation result display screen illustrated in FIG. 5, and thus displays the search/recommendation result display screen on the display 14F.

In step 124, the CPU 16A determines whether the query has been changed. That is, if the query has been changed, the determination result is positive, and the process returns to step 100 to perform the processes described above repeatedly. In contrast, if the query has not been changed, and, for example, if an instruction to end the search is transmitted through the keyboard 14E, the mouse, and the like of the information processing terminal 14, the determination result is negative, and the series of processes end.

### Second Exemplary Embodiment

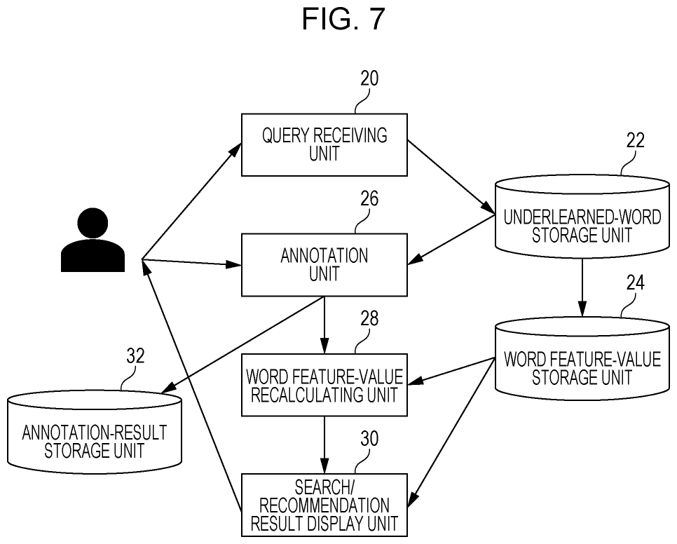

The functional configuration of the server 16 of the information processing system 10 according to a second exemplary embodiment will be described. FIG. 7 is a functional block diagram illustrating the functional configuration of the server 16 of the information processing system 10 according to the second exemplary embodiment. The same configurations as those in the first exemplary embodiment are designated with identical reference numerals, and will not be described.

In the first exemplary embodiment, after the annotation unit 26 performs annotation, the annotation result is used to recalculate the feature value of the word. In the second exemplary embodiment, the annotation result is stored. When a predetermined word-recalculation condition is satisfied, the feature values of words are recalculated.

That is, as illustrated in FIG. 7, the server 16 of the information processing system 10 according to the second exemplary embodiment further includes an annotation-result storage unit 32 in addition to the configuration in the first exemplary embodiment.

The annotation-result storage unit 32, which is implemented, for example, by using the storage 16D, stores annotation results obtained by the annotation unit 26 requesting users to perform annotation operations.

If the predetermined word-recalculation condition is satisfied, the word feature-value recalculating unit 28 uses the annotation results, which are stored in the annotation-result storage unit 32, to recalculate the feature values of the words. The other configurations are the same as those in the first exemplary embodiment, and will not be described in detail.

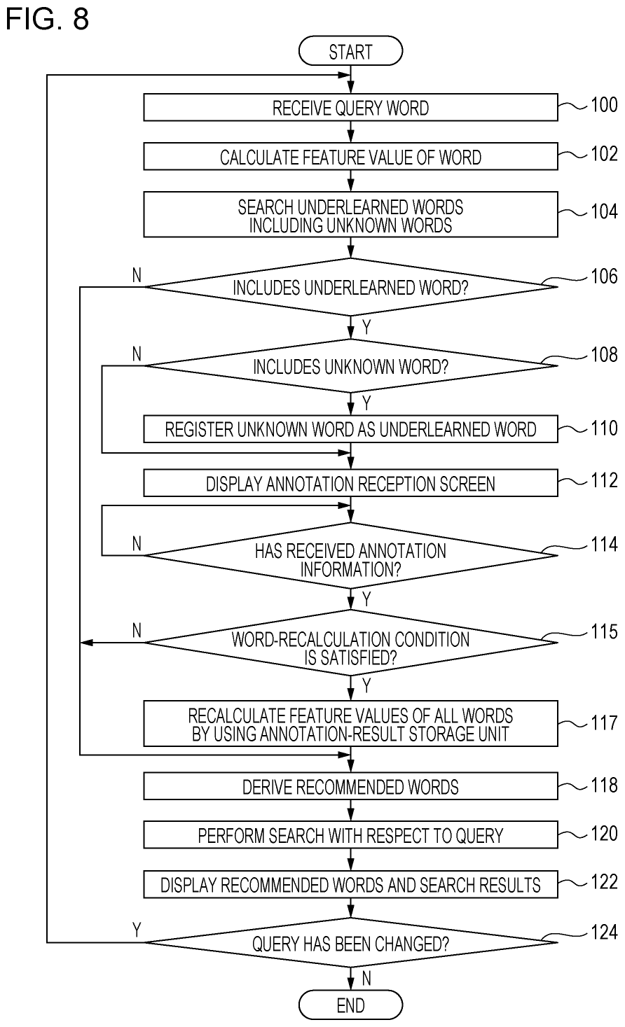

Specific processes performed by the server 16 of the information processing system 10 according to the second exemplary embodiment will be described. FIG. 8 is a flowchart of an exemplary process performed by the server 16 of the information processing system 10 according to the second exemplary embodiment. The process in FIG. 8 starts when the keyboard 14E of an information processing terminal 14 is operated to enter a query. The description will be made by designating the same processes as those in FIG. 6 according to the first exemplary embodiment with identical reference numerals.

In step 100, the CPU 16A receives at least one word for query, and the process proceeds to step 102. That is, the query receiving unit 20 receives at least one word entered as a query by using the information processing terminal 14.

In step 102, the CPU 16A calculates the feature value of the at least one word entered as a query, and the process proceeds to step 104. For example, a technique, such as Word2Vec or FastText, is used to calculate the feature vector of the at least one word.

In step 104, the CPU 16A searches underlearned words including unknown words, and the process proceeds to step 106. That is, the query receiving unit 20 searches the word feature-value storage unit 24 and the underlearned-word storage unit 22 for the at least one word received in step 100. If a word feature value corresponding to the feature value of the at least one word received by the query receiving unit 20 is not found in the word feature-value storage unit 24, the at least one word is regarded as an unknown word. If the at least one word received by the query receiving unit 20 is stored in the underlearned-word storage unit 22, the at least one word is regarded as an underlearned word.

In step 106, the CPU 16A determines whether the at least one word entered as a query includes an underlearned word encompassing an unknown word. That is, the query receiving unit 20 determines whether the at least one word entered as a query includes a word, whose feature value is not stored in the word feature-value storage unit 24, or a word stored in the underlearned-word storage unit 22. If the determination result is positive, the process proceeds to step 108. If the determination result is negative, the process proceeds to step 118.

In step 108, the CPU 16A determines whether the at least one word entered as a query includes an unknown word. That is, the CPU 16A determines whether the at least one word having been determined as an underlearned word is a word which is not stored in the underlearned-word storage unit 22 and whose feature value is not stored in the word feature-value storage unit 24. If the determination result is positive, the process proceeds to step 110. If the determination result is negative, the process proceeds to step 112.

In step 110, the CPU 16A registers the unknown word as an underlearned word with the underlearned-word storage unit 22, and the process proceeds to step 112.

In step 112, the CPU 16A displays the predetermined annotation reception screen on the display 14F of the information processing terminal 14, and the process proceeds to step 114. That is, the annotation unit 26 transmits, to the information processing terminal 14, the predetermined annotation reception screen including the user selection area 42 and the user input area 44 illustrated in FIG. 4, and thus displays the annotation reception screen on the display 14F of the information processing terminal 14.

In step 114, the CPU 16A determines whether annotation information has been received. That is, the annotation unit 26 determines whether a user has operated the keyboard 14E, the mouse, and the like of the information processing terminal 14 to perform an input operation on the annotation reception screen. The process waits until the determination result is positive, and proceeds to step 115.

In step 115, the CPU 16A determines whether the predetermined word-recalculation condition has been satisfied. For example, the word feature-value recalculating unit 28 may determine whether a predetermined number of annotation results have been accumulated in the annotation-result storage unit 32. Alternatively, the word feature-value recalculating unit 28 determines whether a predetermined time has elapsed since recalculation of the feature values of words. Alternatively, the word feature-value recalculating unit 28 determines whether another predetermined condition has been satisfied. If the determination result is positive, the process proceeds to step 117. If the determination result is negative, the process proceeds to step 118.

In step 117, the CPU 16A uses the annotation results, which are stored in the annotation-result storage unit 32, to recalculate the feature values of all the words stored in the word feature-value storage unit 24, and the process proceeds to step 118. That is, the word feature-value recalculating unit 28 uses annotation results, which are stored in the annotation-result storage unit 32, to recalculate the feature values of all the words stored in the word feature-value storage unit 24. Thus, the word feature-value recalculating unit 28 learns various types of underlearned words, and updates the word feature-value storage unit 24. For example, a technique, such as Word2Vec or FastText, is used to calculate the feature vectors of the words. In recalculation of the feature values of the words, information from an external server may be merged into the annotation-result storage unit 32, and the feature values may be recalculated. If learning becomes sufficient, for example, if an underlearned word has been learned a predetermined number of times, the word feature-value recalculating unit 28 may delete the word stored in the underlearned-word storage unit 22, and may exclude the word from the underlearned words. A user may transmit an instruction to exclude the word from the underlearned words.

In step 118, the CPU 16A derives recommended words relating to the at least one word entered as a query, and the process proceeds to step 120. That is, the feature value of the at least one word calculated in step 102 or the feature value of the at least one word recalculated in step 117, and the feature values of the words stored in the word feature-value storage unit 24 are used to derive words, which relate to the at least one word entered as a query, as recommended words.

In step 120, the CPU 16A performs a search with respect to the query, and the process proceeds to step 122. That is, sites, documents, and the like including the at least one word entered as a query are searched for.

In step 122, the CPU 16A displays the recommended words and the search results, and the process proceeds to step 124. That is, the search/recommendation result display unit 30 displays, on the display 14F of the information processing terminal 14, the search results of sites, documents, and the like including the at least one word which is entered as a query and which is received by the query receiving unit 20. The search/recommendation result display unit 30 displays, on the display 14F of the information processing terminal 14, words, which relate to the at least one word which is entered in the input query area and which is received by the query receiving unit 20, as recommendation results. For example, the search/recommendation result display unit 30 transmits, to the information processing terminal 14, the search/recommendation result display screen illustrated in FIG. 5, and thus displays the search/recommendation result display screen on the display 14F.

In step 124, the CPU 16A determines whether the query has been changed. That is, if the query has been changed, the determination result is positive, and the process returns to step 100 to perform the processes described above repeatedly. In contrast, if the query has not been changed, and, for example, if an instruction to end the search is transmitted through the keyboard 14E, the mouse, and the like of the information processing terminal 14, the determination result is negative, and the series of processes end.

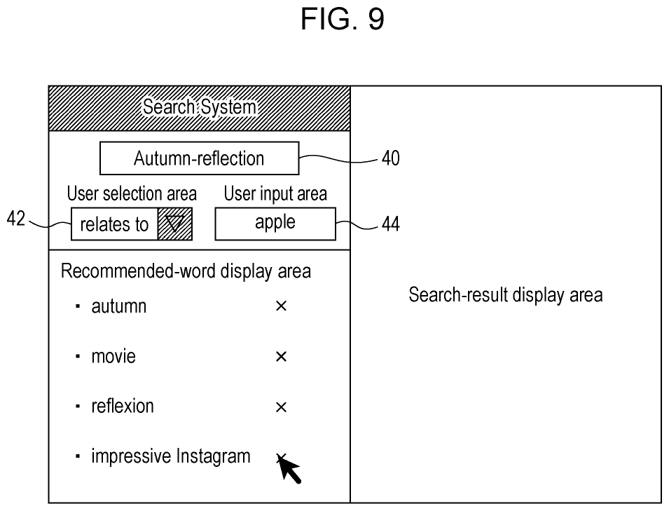

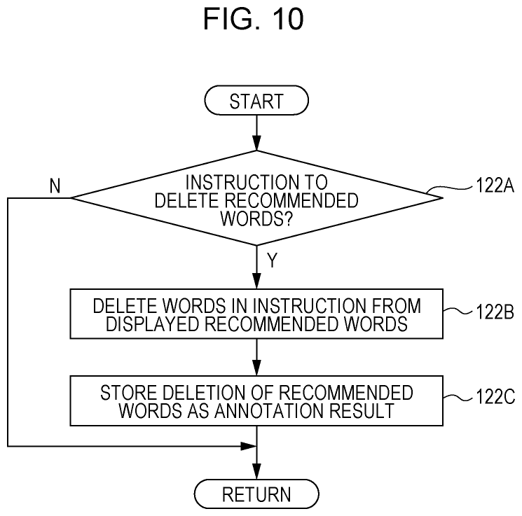

In display of search results and recommendation results in step 122 in the second exemplary embodiment, non-related words may be deleted from the words displayed in the recommended-word area. For example, “NG” corresponding to a word displayed in the recommended-word display area in FIG. 9 may be operated to delete the word. In this case, the deletion result may be stored in the annotation-result storage unit 32 as an annotation result. In this case, the process in FIG. 10 is performed between step 122 and step 124. FIG. 10 is a flowchart of an exemplary process performed when non-related recommended words may be deleted.

That is, when recommended words and search results are displayed in step 122, the process proceeds to step 122A.

In step 122A, the CPU 16A determines whether an instruction to delete recommended words has been transmitted. That is, the CPU 16A determines whether a user has operated the keyboard 14E, the mouse, and the like of the information processing terminal 14 to transmit an instruction to delete recommended words. If the determination result is positive, the process proceeds to step 122B. If the determination result is negative, the process proceeds to step 124.

In step 122B, the CPU 16A deletes the words, which an instruction to delete has been transmitted, from the displayed recommended words, and the process proceeds to step 122C.

In step 122C, the CPU 16A stores, in the annotation-result storage unit 32, the deletion of recommended words as an annotation result, and the process proceeds to step 124 described above.

In the exemplary embodiments described above, the example in which a predicate and an object for a query entered by a user are requested as annotation information from the user is described. The annotation method performed by the annotation unit 26 is not limited to this. For example, in a request of input of annotation information for a query entered by a user, an answer indicating whether there is a relationship may be requested. For example, input of annotation information for the word, “Autumn-reflection”, which is entered as a query is requested from a user. When “apple” is entered as its result, “Does Autumn-reflection relate to an apple?” may be displayed, and a “Yes”/“No” answer may be requested. Alternatively, for example, “How much is Autumn-reflection similar to an apple?Answer the degree in the range between 0 and 5.” may be displayed and annotation may be requested.

In the exemplary embodiments described above, a word, whose feature value is not stored in the word feature-value storage unit 24, or a word, which is stored in the underlearned-word storage unit 22, is determined to be an underlearned word. The determination of an underlearned word is not limited to this. For example, for even a word, whose feature value is stored in the word feature-value storage unit 24 and which is not stored in the underlearned-word storage unit 22, if the degree of similarity in feature value between the word and a word, which is stored in the underlearned-word storage unit 22, is equal to or greater than a predetermined threshold, the word may be determined to be an underlearned word, and annotation may be performed.

In the exemplary embodiments described above, the example in which the server 16 includes the underlearned-word storage unit 22, the word feature-value storage unit 24, and the annotation-result storage unit 32 is described. This is not limiting. For example, a different external server may include these units. Alternatively, the storage units may be included in corresponding different external servers. Alternatively, some of the storage units may be included in a different external server.

In the embodiments above, the term “processor” refers to hardware in a broad sense. Examples of the processor include general processors (e.g., CPU) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The process performed by the server 16 according to the exemplary embodiments described above may be performed through software, hardware, or a combination of these. The process performed by the server 16 may be distributed by storing the process as a program in a storage medium.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
receive a query; and,
when the received query includes a predetermined underlearned word, receive, as information for learning the underlearned word, annotation information for the underlearned word.

2. The information processing apparatus according to claim 1,
wherein the processor is further configured to:
use the received annotation information to learn the underlearned word.

3. The information processing apparatus according to claim 2,
wherein the processor is further configured to:
use the received annotation information to recalculate a feature value of the underlearned word; and
use the recalculated feature value to derive a recommended word relating to the word included in the received query.

4. The information processing apparatus according to claim 1,
wherein the processor is configured to:
in reception of the annotation information, display a predetermined annotation reception screen for receiving a word for annotation; and
receive the annotation information through the annotation reception screen.

5. The information processing apparatus according to claim 2,
wherein the processor is configured to:
in reception of the annotation information, display a predetermined annotation reception screen for receiving a word for annotation; and
receive the annotation information through the annotation reception screen.

6. The information processing apparatus according to claim 3,
wherein the processor is configured to:
in reception of the annotation information, display a predetermined annotation reception screen for receiving a word for annotation; and
receive the annotation information through the annotation reception screen.

7. The information processing apparatus according to claim 4,
wherein the annotation reception screen includes an area in which a recommended word is displayed, and an area in which a search result for the query is displayed.

8. The information processing apparatus according to claim 5,
wherein the annotation reception screen includes an area in which a recommended word is displayed, and an area in which a search result for the query is displayed.

9. The information processing apparatus according to claim 6,
wherein the annotation reception screen includes an area in which a recommended word is displayed, and an area in which a search result for the query is displayed.

10. The information processing apparatus according to claim 1,
wherein the processor is configured to:
receive, as the annotation information, words corresponding to a predicate and an object for the underlearned word included in the query.

11. The information processing apparatus according to claim 2,
wherein the processor is configured to:
receive, as the annotation information, words corresponding to a predicate and an object for the underlearned word included in the query.

12. The information processing apparatus according to claim 3,
wherein the processor is configured to:
receive, as the annotation information, words corresponding to a predicate and an object for the underlearned word included in the query.

13. The information processing apparatus according to claim 10,
wherein the word corresponding to the predicate is allowed to be selected from a plurality of predetermined candidates.

14. The information processing apparatus according to claim 1,
wherein the processor is configured to:
when the received query includes an unknown word, register the unknown word as an underlearned word.

15. The information processing apparatus according to claim 1,
wherein the processor is configured to:
in response to failure in obtaining a desired result for the received query, perform a process of registration as an underlearned word.

16. The information processing apparatus according to claim 2,
wherein the processor is configured to:
when a predetermined condition is satisfied in learning the underlearned word, exclude the underlearned word.

17. The information processing apparatus according to claim 1,
wherein the processor is further configured to:
display a recommended word for the received query;
receive deletion of a non-related recommended word; and
receive the received result as the annotation information.

18. The information processing apparatus according to claim 1,
wherein the processor is further configured to:
when the query includes a word having a degree of similarity to the underlearned word, the degree of similarity being equal to or greater than a predetermined threshold, receive the annotation information.

19. An information processing system comprising:
the information processing apparatus according to claim 1; and
an information processing terminal that inputs the query and the annotation information for the underlearned word.

20. A non-transitory computer readable medium storing a program causing a computer to execute a process for information processing, the process comprising:
receiving a query for search; and,
when the received query includes a predetermined underlearned word, receiving, as information for learning the underlearned word, annotation information for the underlearned word.
